(19) United States
(12) Patent Application Publication
(10) Pub. No.: US 2009/0232445 A1
(43) Pub. Date: Sep. 17, 2009

(54) OPTICAL WAVEGUIDE DEVICE, OPTICAL INTEGRATED DEVICE AND OPTICAL TRANSMISSION DEVICE

(75) Inventor: Seok-Hwan JEONG, Kawasaki (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: FUJITSU LIMITED, Kawasaki-shi (JP)

(21) Appl. No.: 12/401,315

(22) Filed: Mar. 10, 2009

(30) Foreign Application Priority Data
Mar. 13, 2008 (JP) 2008-064520

(51) Int. Cl. G02B 6/12; G02B 6/26

(52) U.S. Cl. 385/14; 385/43

(57) ABSTRACT

An optical waveguide device including a first waveguide, a plurality of second waveguides, and a tapered waveguide including a first end connected to the first waveguide and a second end connected to the plurality of second waveguides and configured to receive input of single-mode light from the first waveguide, the tapered waveguide widening as the tapered waveguide extends from the first end toward the second end.

### CROSS-REFERENCE TO RELATED APPLICATIONS

This application is based upon and claims the benefit of priority from prior Japanese Patent Application No. 2008-064520, filed on Mar. 13, 2008, the entire contents of which are incorporated herein by reference.

### FIELD

The concepts discussed herein relate to an optical waveguide device, an optical integrated device, and an optical transmission device.

### BACKGROUND

In recent years, optical communication systems have employed a wavelength multiplexing signal processing method and, hence, a transmission capacity of the optical communication system has increased remarkably.

Such optical communication systems need an optical coupler for branching and coupling optical signals in order to perform various types of optical signal processing.

Examples of requirements for the optical coupler (i.e., optical branching/multiplexing device) used in the optical communication system include broadband performance of operating wavelength (i.e., low wavelength dependence), polarization independence (i.e., low polarization dependence), large fabrication tolerance, compactness, and monolithic integratability.

Examples of optical couplers suitable for monolithic integration include a Y-branch coupler (see FIG. 20A for example), a directional coupler (see FIG. 20B for example), a star coupler (see FIG. 21 for example), a multimode interference (MMI) coupler (see FIG. 22 for example), and a mode-converting coupler.

With respect to the Y-branch coupler and the directional coupler, the device size substantially increases undesirably as the number of channels increases with multichanneling.

With respect to the star coupler, there is a concern about occurrence of interchannel imbalance on the output side because a light intensity distribution in a coupler region is of a Gaussian function type.

With respect to the MMI coupler, since the device length is proportional to the square of the width of an MMI region, the device increases in size and the wavelength dependence and the polarization dependence become more conspicuous as the number of channels increases with multichanneling.

### SUMMARY

Accordingly, it is an object in one aspect of the invention to provide an optical waveguide device includes a first waveguide, a plurality of second waveguides, and a tapered waveguide including a first end connected to the first waveguide and a second end connected to the plurality of second waveguides and configured to receive input of single-mode light from the first waveguide, the tapered waveguide widening as the tapered waveguide extends from the first end toward the second end.

The object and advantages of the concepts discussed herein will be realized and attained by means of the elements and combinations particularly pointed out in the claims.

It is to be understood that both the foregoing general description and the following detailed description are exemplary and explanatory and are not restrictive of the concepts, as claimed.

### BRIEF DESCRIPTION OF THE DRAWINGS

FIG. 1 is a schematic view illustrating a mode-converting optical coupler according to one embodiment of the present invention;

FIG. 2 is a diagram illustrating transmission characteristics and light intensity distributions of a mode-converting optical coupler according to one embodiment of the present invention;

FIG. 3 is a schematic view illustrating a mode-converting optical coupler according to a comparative example of one embodiment of the present invention;

FIG. 4 is a diagram illustrating transmission characteristics and light intensity distributions of a mode-converting optical coupler according to a comparative example of one embodiment of the present invention;

FIG. 5 is a diagram illustrating light intensity distributions at the widest end of a tapered waveguide in a mode-converting optical coupler according to one embodiment of the present invention;

FIG. 6 is a diagram illustrating light intensity distributions at the widest end of a tapered waveguide in a mode-converting optical coupler according to a comparative example of one embodiment of the present invention;

FIG. 7 is a diagram illustrating a relationship between a Dw value and a value indicative of interchannel imbalance in a mode-converting optical coupler according to one embodiment of the present invention;

FIG. 8 is a diagram illustrating a relationship between transmission characteristics and a Dw value in a mode-converting optical coupler according to one embodiment of the present invention;

FIG. 9 is a schematic sectional view illustrating a mode-converting optical coupler according to one embodiment of the present invention;

FIGS. 10A and 10B are each a diagram illustrating input/output transmission characteristics (normalized transmittances) of a mode-converting optical coupler according to one embodiment of the present invention;

FIGS. 11A and 11B are each a diagram illustrating characteristics indicative of interchannel imbalance in a mode-converting optical coupler according to one embodiment of the present invention;

FIGS. 12A and 12B are each a diagram illustrating characteristics indicative of interchannel imbalance in a mode-converting optical coupler according to a comparative example of one embodiment of the present invention;

FIG. 13 is a schematic view illustrating a mode-converting optical coupler according to a variation of one embodiment of the present invention;

FIG. 14 is a diagram illustrating transmission characteristics of a mode-converting optical coupler according to a variation of one embodiment of the present invention;

FIG. 15 is a schematic view illustrating an optical integrated device according to one embodiment of the present invention;

FIG. 16 is a schematic view illustrating another optical integrated device according to one embodiment of the present invention;

FIG. 17 is a schematic view illustrating yet another optical integrated device according to one embodiment of the present invention;

FIG. 18 is a schematic view illustrating yet another optical integrated device according to one embodiment of the present invention;

FIG. 19 is a schematic view illustrating yet another optical integrated device according to one embodiment of the present invention;

FIG. 20A is a schematic view illustrating a Y-branch coupler;

FIG. 20B is a schematic view illustrating a directional coupler;

FIG. 21 is a schematic view illustrating a star coupler; and

FIG. 22 is a schematic view illustrating a multimode interference coupler.

### DESCRIPTION OF EMBODIMENTS

As compared with an MMI coupler, a mode-converting coupler using a tapered waveguide has a device size which increases to a smaller extent with increasing number of channels and is capable of multichanneling with a compact device size. In addition, such a mode-converting coupler is lower in wavelength dependence and in polarization dependence.

However, a mode-converting coupler wherein a plurality of output waveguides are connected to a wider end portion of the tapered waveguide, shows a tendency that its transmittance lowers as the tapered waveguide extends from the center of its wider end portion toward ends of the wider end portion and hence might allow interchannel imbalance to occur on the output side.

As a result of intensive study made by the inventor, it has been found out that the length of the tapered waveguide used in the mode-converting coupler need be controlled with precision in order to provide a substantially flat light intensity distribution at the wider end of the tapered waveguide and, hence, the fabrication tolerance of the mode-converting coupler is small.

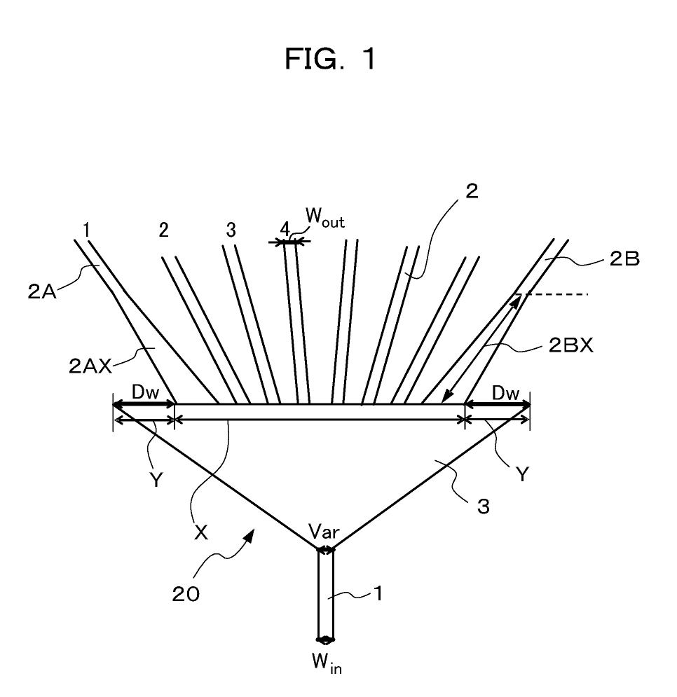

Hereinafter, an optical waveguide device, an optical integrated device and an optical transmission device according to the present embodiment will be described with reference to FIGS. 1 to 19.

The optical waveguide device according to the present embodiment is a mode-converting optical coupler 20 configured to branch and couple optical signals using a tapered waveguide (i.e., optical coupler module device, optical branching/multiplexing device, or optical branch coupler), as illustrated in FIG. 1. The mode-converting optical coupler 20 includes one single-mode input waveguide (first waveguide) 1, a plurality of (eight in the example illustrated) output waveguides (second waveguides) 2, and a tapered waveguide 3 having first end connected to the input waveguide 1 and a second end connected to the output waveguide 2 and gradually widening as the tapered waveguide 3 extends from first end (i.e., input-side end or input end) toward a second end (i.e., output-side end or output end).

Such an optical coupler 20 is used alone as a device for branching and coupling (multiplexing) optical signals in an optical communication system for example. Alternatively, the optical coupler 20 is widely used to connect active elements and passive elements in an optical integrated device in which a plurality of such active elements and a plurality of such passive elements are integrated together for higher functionality. Here, the whole of the input waveguide 1, output waveguides 2 and tapered waveguide 3 is regarded as a mode-converting optical coupler. However, it is possible that the tapered waveguide 3 is regarded as a mode-converting optical coupler to which the input waveguide 1 and the output waveguides 2 are connected.

In the present embodiment, the tapered waveguide 3 widens linearly (i.e., nonadiabatically) as the tapered waveguide 3 extends from the input waveguide 1 side toward the output waveguide 2 side. The tapered waveguide 3 has a tapered shape optimized by a numeric analysis technique to make a light intensity distribution substantially flat at its output end (i.e., widest end). That is, the shape of the tapered waveguide 3 controls higher-order mode excitation to achieve mode conversion. For this reason, the tapered waveguide 3 is also called “mode-converting waveguide”.

The input end width (i.e., narrowest end width (Var)) of the tapered waveguide 3 is substantially equal to the width (Win) of the input waveguide 1 (Var=Win), as illustrated in FIG. 1. The input end width of the tapered waveguide 3 need not necessarily be equal to the width of the input waveguide 1 as long as the input end width is set to satisfy a single-mode condition.

Thus, input light propagating through the input waveguide 1 is inputted in a single-mode form to the tapered waveguide 3. That is, any higher-order mode excitation does not occur when the input light enters the tapered waveguide 3. In this case, single-mode input light having entered the tapered waveguide 3 is subjected to mode conversion by being coupled to higher-order modes excited sequentially without bringing about a self-imaging phenomenon (i.e., self-imaging effect) during propagation within the tapered waveguide 3.

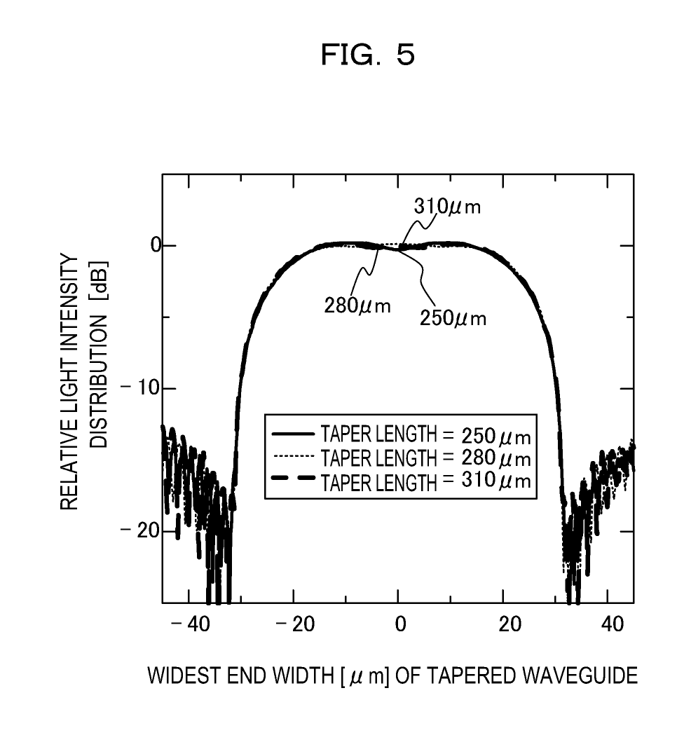

In the present embodiment, the output end of the tapered waveguide 3 has regions Y which project outwardly from opposite ends of a region X connected to the plurality of output waveguides 2, as illustrated in FIG. 1. (The length of each region Y is Dw.) The output end width (i.e., widest end width) of the tapered waveguide 3 is set to meet an intended light intensity distribution at the output end. That is, though the light intensity distribution at the output end of the tapered waveguide 3 is shaped parabolic (see FIG. 5 for example), the output end width is set so that the light intensity distribution (light intensity characteristic) is made substantially flat in the region X connected to the plurality of output waveguides 2 at the output end of the tapered waveguide 3 and changes largely in the regions Y projecting outwardly from the opposite ends of the region X.

For this purpose, the widest end width of the tapered waveguide 3 is made larger by a given value than the sum of the widths of the respective output waveguides 2 and the spaces each defined between adjacent ones of the waveguides 2. That is, the value twice as large as the value of Dw (i.e., Dw width) illustrated in FIG. 1 is the difference between the widest end width of the tapered waveguide 3 and the sum of the widths of the respective output waveguides 2 and the spaces each defined between adjacent ones of the waveguides 2.

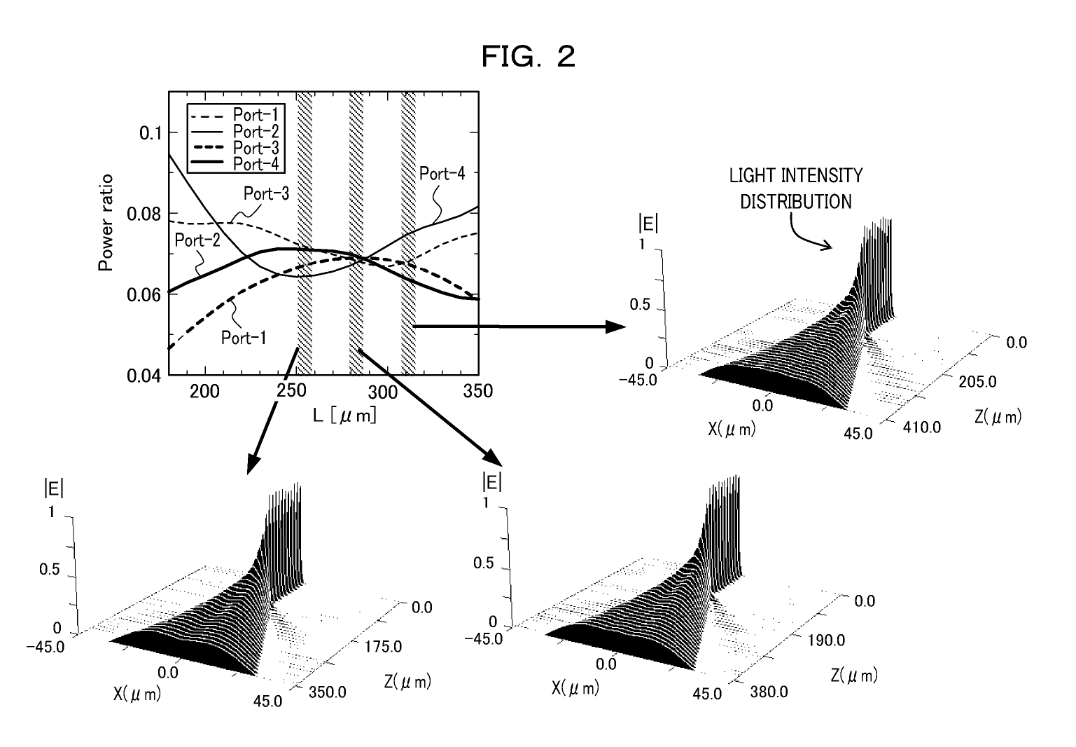

In the present embodiment, the plurality of output waveguides 2 have their respective widths (Wout) which are set so that the output waveguides 2 have respective transmission characteristics substantially equal to each other. Here, the widths of the respective output waveguides 2 are optimized by a numeric analysis technique. In FIG. 1, numbers 1 to 4 given to four output waveguides correspond to ports 1 to 4 of FIG. 2.

As illustrated in FIG. 1, the outermost output waveguides 2A and 2B, in particular, of the plurality of output waveguides 2 (which are each located closest to a respective one of the opposite side ends of the output end portion of the tapered waveguide 3) have tapered portions 2AX and 2BX, respectively, which gradually widen as they extend toward the output end of the tapered waveguide 3. The tapered portions 2AX and 2BX each have a taper angle to such a degree as to enable a higher-order mode to be converted to a single mode. Thus, a higher-order mode is converted to a single mode during propagation of light through each of the tapered portions 2AX and 2BX.

As described above, the input end width (Var) of the tapered waveguide 3 is set to satisfy the single-mode condition in the present embodiment. For this reason, the present embodiment is capable of avoiding occurrence of interference between a fundamental mode and a second higher-order mode, thereby increasing the fabrication tolerance substantially. This feature will be described below in detail.

FIG. 2 illustrates power ratios and light intensity distributions which are indicative of transmission characteristics of the present mode-converting optical coupler.

The mode-converting optical coupler used in FIG. 2 is a 1×8 mode-converting optical coupler 20 having a single port on the input side (i.e., input port; input waveguide) and eight ports on the output side (i.e., output ports; output waveguides), wherein: any one of the input waveguide 1 and output waveguides 2 has a width of 1.6 μm; the narrowest end width and the widest end width of the tapered waveguide 3 are 1.6 μm and 62 μm, respectively; the space between adjacent ones of the output waveguides 2 is 3.5 μm; and the widest end width, narrowest end width and length of each of the tapered portions 2AX and 2BX of the outermost output waveguides 2A and 2B are 4.0 μm, 1.6 μm, and 100 μm, respectively (see FIG. 1). (The tapered portions 2AX and 2BX are each a width-tapered waveguide portion having a length of 100 μm.)

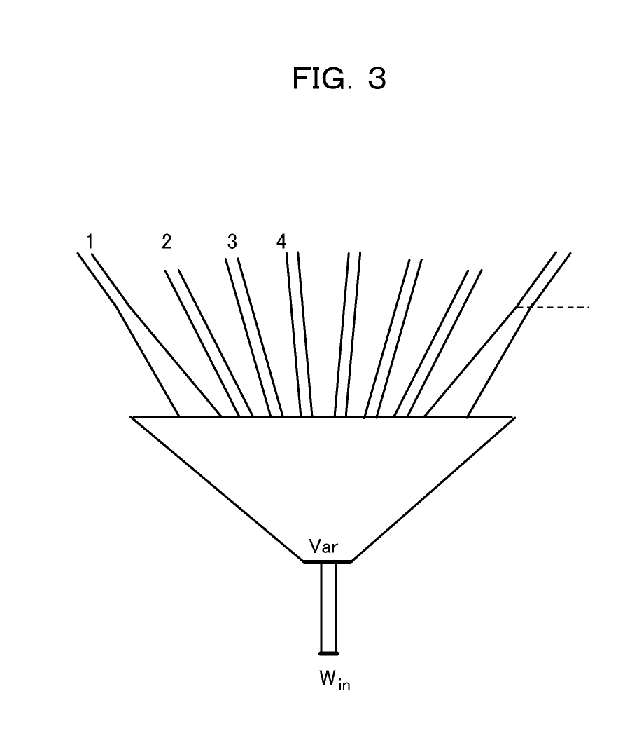

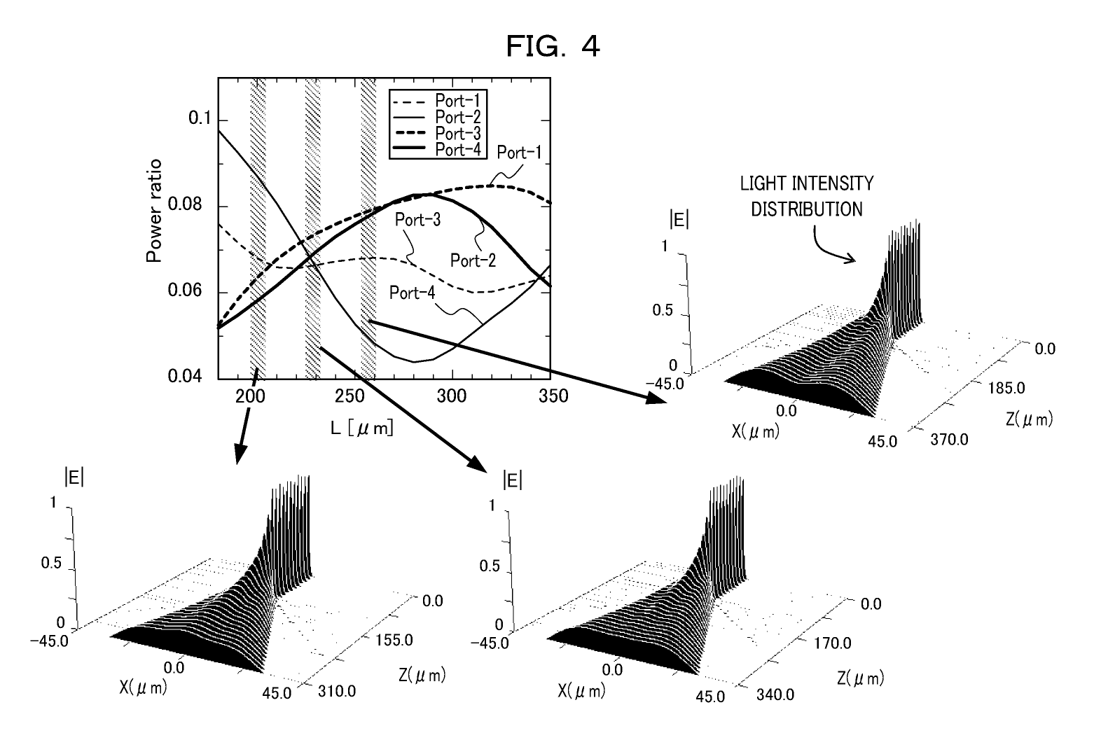

FIG. 3 is a schematic view illustrating a mode-converting optical coupler according to a comparative example of the present mode-converting optical coupler. FIG. 4 illustrates power ratios and light intensity distributions which are indicative of transmission characteristics of the mode-converting optical coupler in the comparative example. In FIG. 3, numbers 1 to 4 given to four output waveguides correspond to ports 1 to 4 of FIG. 4.

The narrowest end width (Var) of the tapered waveguide of the comparative example is different from that of the tapered waveguide of the present mode-converting optical coupler 20, as illustrated in FIG. 3. Specifically, in the comparative example, the narrowest end width (Var) of the tapered region is larger than the width (Win) of the input waveguide and is set large enough to allow higher-order mode excitation to occur. The dimensions set in the comparative example are equal to the corresponding dimensions set in the above-described embodiment except that the narrowest end width and the widest end width of the tapered waveguide are set to 3.0 μm and 60 μm, respectively.

Though FIGS. 2 and 4 each illustrate the transmission characteristics of only four channels (specifically, the ratios of light powers outputted from four output ports (ports 1 to 4) to a light power inputted from the single input port; i.e., transmittances), the transmission characteristics of the other four channels are identical with the respective transmission characteristics illustrated because the device has a symmetric structure with respect to a central axis thereof.

The comparative example (see FIG. 3) intentionally allows higher-order mode excitation other than single-mode excitation to occur upon entry of input light into the tapered waveguide by setting the length (L) of the tapered waveguide to an optimum length (about 230 μm in the example shown) as illustrated in FIG. 4, thereby suppressing variations in transmission characteristic among the channels (i.e., interchannel imbalance; interchannel deviation) to make a light intensity distribution flat at the output end of the tapered waveguide.

However, as illustrated in FIG. 4, when the length of the tapered waveguide becomes slightly smaller (about 200 μm in the example shown) or slightly larger (about 260 μm in the example shown) than the optimum length, large variations in transmission characteristic occur among the channels to collapse the flatness of the light intensity distribution at the output end of the tapered waveguide.

For this reason, the length of the tapered waveguide need be controlled with precision in order to suppress variations in transmission characteristic among the channels thereby to make the light intensity distribution substantially flat at the output end of the tapered waveguide. This means that the comparative example illustrated in FIG. 3 has a small fabrication tolerance.

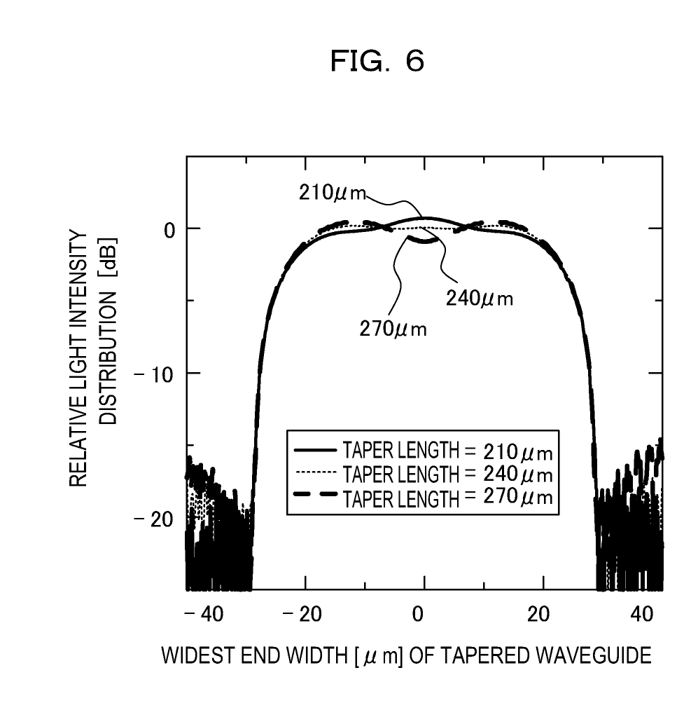

FIG. 6 illustrates light intensity distributions (relative light intensity distributions) at the output end (widest end) of the tapered waveguide in the comparative example. In FIG. 6, light intensity distribution characteristics are illustrated which are obtained when the length of the tapered waveguide (taper length) is varied as 210 μm, 240 μm and 270 μm.

As can be seen from FIG. 6, the comparative example (see FIG. 3) allows the substantially flat light intensity distribution to collapse when the length of the tapered waveguide becomes larger or smaller by about 30 μm than an optimum value (240 μm in the example shown). That is, the comparative example intentionally allows higher-order mode excitation other than single-mode excitation to occur upon entry of input light into the tapered waveguide. Therefore, even when the length of the tapered waveguide varies, interference between the fundamental mode and the second higher-order mode affects the light intensity distribution at the output end of the tapered waveguide, thereby collapsing the flatness of the light intensity distribution at the output end of the tapered waveguide.

Thus, when the tapered waveguide length is varied by fabrication errors or the like, the light intensity distribution cannot be made flat at the output end of the tapered waveguide, which will result in poor fabrication yield.

As can be seen from FIG. 2, by contrast, the present mode-converting optical coupler 20 has a wider range in which variations in transmission characteristic among the channels are small than the comparative example and, hence, the substantially flat light intensity distribution is maintained at the output end of the tapered waveguide 3 even when the length (L) of the tapered waveguide 3 varies.

Assuming that an allowable range of variations in transmission characteristic among the channels is 0.5 dB, the present mode-converting optical coupler 20 has a device length margin of about 55 μm as illustrated in FIG. 2, whereas the above-described comparative example has a device length margin of about 9 μm as illustrated in FIG. 4. That is, the device length margin of the present mode-converting optical coupler 20 is more than six times as large as that of the comparative example, which proves that the present mode-converting optical coupler 20 has a substantially increased fabrication tolerance.

FIG. 5 illustrates light intensity distributions (relative light intensity distributions) at the output end (widest end) of the tapered waveguide in the present mode-converting optical coupler 20. In FIG. 5, light intensity distribution characteristics are illustrated which are obtained when the length of the tapered waveguide (taper length) is varied as 250 μm, 280 μm and 310 μm.

As can be seen from FIG. 5, the structure of the present mode-converting optical coupler 20 (see FIG. 1) maintains a substantially flat light intensity distribution even when the length of the tapered waveguide 3 (within a range from 250 μm to 310 μm in the example shown) becomes larger or smaller by about 30 μm than an optimum value (280 μm in the example shown). That is, the structure of the present mode-converting optical coupler 20 does not allow higher-order mode excitation to occur upon entry of input light into the tapered waveguide 3 because single-mode input is made to tapered waveguide 3. Therefore, interference does not occur between the fundamental mode and the second higher-order mode and, hence, the flatness of the light intensity distribution at the output end of the tapered waveguide 3 is not collapsed.

Thus, even when the length of the tapered waveguide 3 is varied by fabrication errors or the like, the flatness of the light intensity distribution can be maintained at the output end of the tapered waveguide 3. For this reason, the mode-converting optical coupler 20 in which variations in transmission characteristic among the channels are suppressed can be fabricated in high yield.

Meanwhile, the light intensity distribution at the output end of the tapered waveguide 3 is shaped parabolic and the light intensity changes steeply on opposite sides (see FIG. 5 for example). If the light intensity steeply changes in the region X connected to the plurality of output waveguides 2 at the output end of the tapered waveguide 3 (see FIG. 1), large interchannel imbalance occurs undesirably.

To obviate such an inconvenience, the present embodiment has an arrangement wherein: the output end of the tapered waveguide 3 has regions Y which project outwardly from opposite ends of the region X connected to the plurality of output waveguides 2, as illustrated in FIG. 1; and the width Dw of each region Y is set to an appropriate value meeting an intended light intensity distribution at the output end of the tapered waveguide 3.

This arrangement makes the light intensity distribution have a substantially flat shape in the region X connected to the plurality of output waveguides 2 at the output end of the tapered waveguide 3. That is, it is possible to substantially equalize intensities of light propagated to the respective output waveguides 2 connected to the output end of the tapered waveguide 3 (i.e., transmittances of the respective channels), thereby to suppress the occurrence of interchannel imbalance.

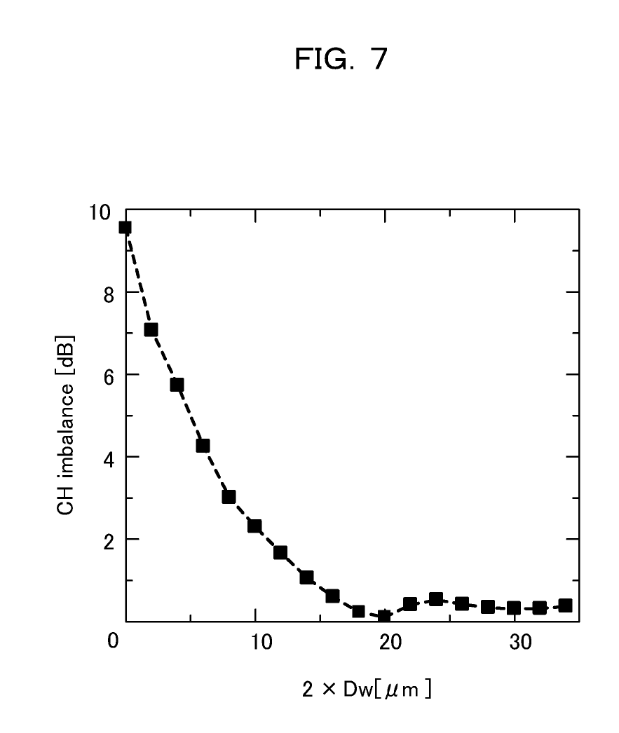

FIG. 7 illustrates a value (dB) indicative of interchannel imbalance relative to the length (Dw value) of each of the regions Y projecting outwardly from the opposite ends of the region X of the tapered waveguide 3 connected to the plurality of output waveguides 2 in the present mode-converting optical coupler 20. Parameters used in this numeric simulation each remain the same as in FIG. 2.

Here, the value indicative of interchannel imbalance is the difference between maximum transmittance and minimum transmittance of the transmittances of the respective output ports. The length of the tapered waveguide 3 is adjusted to an optimum value for each Dw value.

Since the light intensity distribution at the output end of the tapered waveguide 3 is shaped parabolic, the interchannel imbalance increases as the Dw value comes closer to 0, as illustrated in FIG. 7. On the other hand, the interchannel imbalance decreases as the Dw value increases.

When the Dw value is 10 μm (2×Dw=20 μm) for example, the interchannel imbalance decreases to 0.11 dB. As can be seen from FIG. 7, the interchannel imbalance is maintained at 0.5 dB or less when the Dw value is not less than 10 μm (20 μm in total). Thus, the Dw value is a very important parameter in solving the problem of interchannel imbalance.

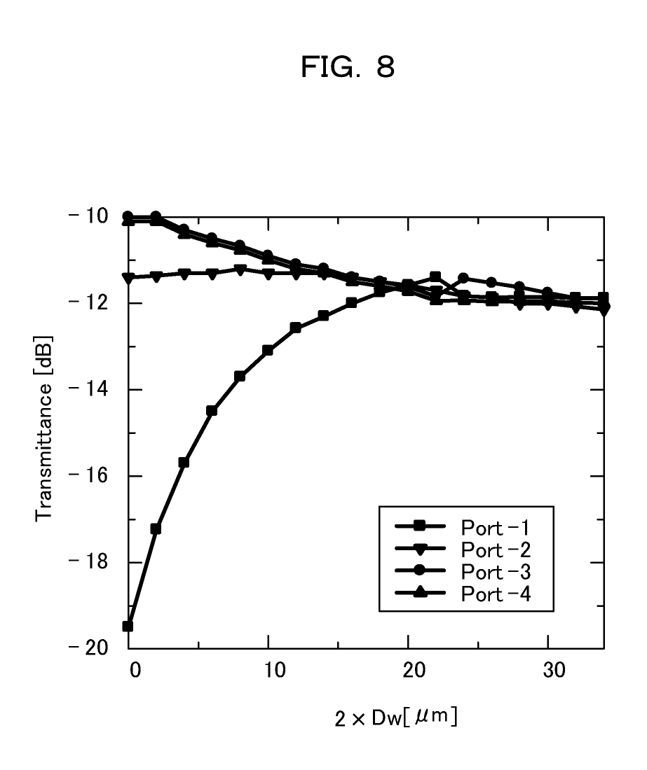

FIG. 8 illustrates a relationship between a transmittance indicative of a transmission characteristic of the present mode-converting optical coupler and the Dw value.

Though FIG. 8 illustrates the transmission characteristics of only four channels (specifically, the ratios of light powers outputted from four output ports (ports 1 to 4) to a light power inputted from the single input port; i.e., transmittances), the transmission characteristics of the other four channels are identical with the respective transmission characteristics illustrated because the device has a symmetric structure with respect to a central axis thereof.

As can be seen from FIG. 8, when the Dw value is not less than 10 μm (20 μm in total), variations in transmission characteristic among the channels are suppressed and the interchannel imbalance is controlled to 0.5 dB or less.

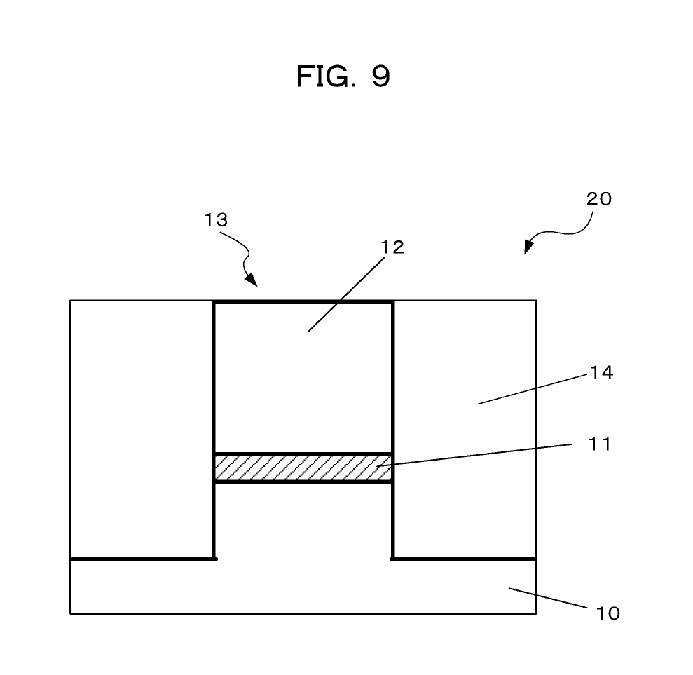

An optical waveguide device (i.e., mode-converting optical coupler) fabrication method (i.e., semiconductor optical waveguide fabrication process) according to the present embodiment will be described with reference to FIG. 9.

Initially, an undoped GaInAsP core layer 11 (emission wavelength: 1.30 μm, layer thickness: 0.2 μm) and an undoped (or p-doped) InP layer 12 (layer thickness: 2.0 μm) are epitaxially grown sequentially on an n-type InP substrate (or an undoped InP substrate) 10 by metal organic vapor phase epitaxy (MOVPE) for example (see FIG. 9).

Subsequently, an SiO₂ film for example is deposited over a surface of the wafer having subjected to epitaxial growth as described above by using a vapor deposition system for example. The SiO₂ film thus deposited is patterned by a photolithography process for example to form a waveguide pattern for forming the mode-converting optical coupler 20.

Subsequently, the wafer is subjected to dry etching by a process such as inductive coupled plasma-reactive ion etching (ICP-RIE) for example using the SiO₂ film thus patterned as a mask, to form a high-mesa waveguide stripe structure 13 having a height of about 3 μm for example (see FIG. 9).

Subsequently, burying crystal growth is performed by MOVPE for example so that the high-mesa waveguide stripe structure 13 is buried with a semi-insulating InP burying layer 14, to form a high-resistant buried waveguide structure (see FIG. 9).

The present mode-converting optical coupler 20 is completed through the fabrication process described above (see FIG. 9).

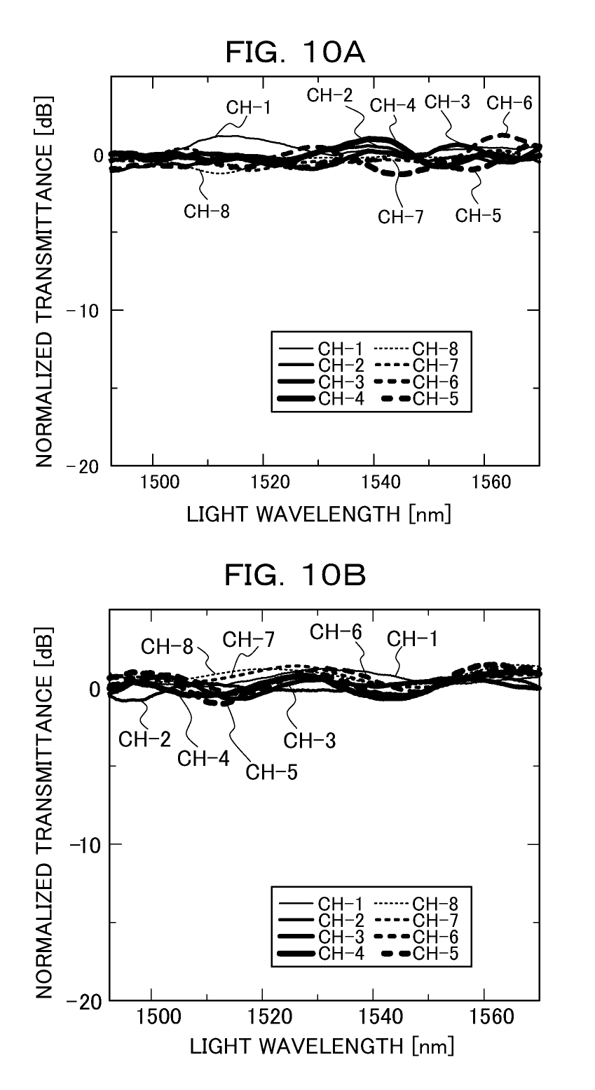

FIGS. 10A and 10B each illustrate input/output transmission characteristics (normalized transmittances) of the mode-converting optical coupler fabricated through the above-described fabrication process. Specifically, FIG. 10A illustrates input/output transmission characteristics (normalized transmittances) for TE-mode input light obtained when the length of the tapered waveguide 3 is 250 μm, while FIG. 10B illustrates input/output transmission characteristics (normalized transmittances) for TE-mode input light obtained when the length of the tapered waveguide 3 is 300 μm.

Here, the Dw value and the widest end width of the tapered waveguide 3, which are used as device parameters, are set to 13 μm and 68.1 μm, respectively. Other parameters (including the width of each of the input waveguide 1 and output waveguides 2, the narrowest end width of the tapered waveguide 3, the space between adjacent ones of the output waveguides 2, and the widest end width, narrowest end width and length of each of the tapered portions 2AX and 2BX of the outermost output waveguides 2A and 2B) each remain the same as in the case of FIG. 2.

Since the present mode-converting optical coupler 20 has a large fabrication tolerance, the output ports (output waveguides 2) have respective transmittances held substantially constant even when the device length varies by 50 μm or more, as can be seen from FIGS. 10A and 10B. As can be also seen, even when the device length varies, the transmission characteristics of the present mode-converting optical coupler 20 are substantially flat within a wavelength range from the S band to the C band and, hence, the present mode-converting optical coupler 20 has low wavelength dependence.

Although input/output transmission characteristics for TM-mode input light are not illustrated here, the input/output transmission characteristics for TM-mode input light have been experimentally confirmed to have low wavelength dependence like the input/output transmission characteristics for TE-mode input light.

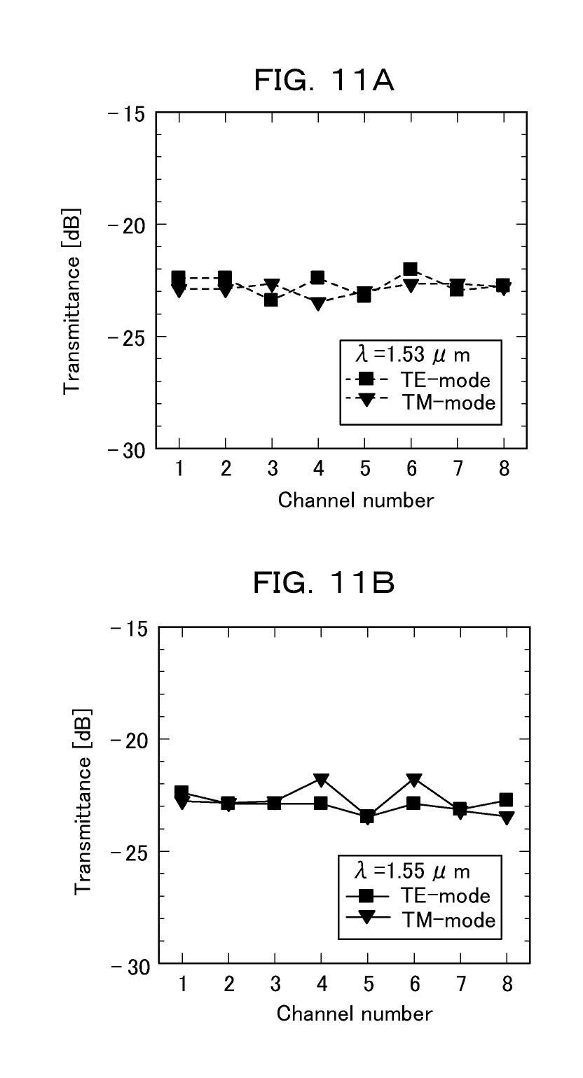

FIGS. 11A and 11B each illustrate characteristics indicative of interchannel imbalance in the present mode-converting optical coupler. Specifically, FIG. 11A illustrates transmittances of each channel (each output port) for TE-mode input light and TM-mode input light obtained when the input light wavelength (λ) is 1.53 μm, while FIG. 11B illustrates transmittances of each channel (each output port) for TE-mode input light and TM-mode input light obtained when the input light wavelength (λ) is 1.55 μm. Device parameters used here each remain the same as in the case of FIG. 10A.

As can be seen from FIGS. 11A and 11B, the interchannel imbalance is suppressed to 1.5 dB or less regardless of the input light wavelength. As can be also seen, the polarization dependence is controlled to 1 dB or less and, hence, the present mode-converting optical coupler has low polarization dependence.

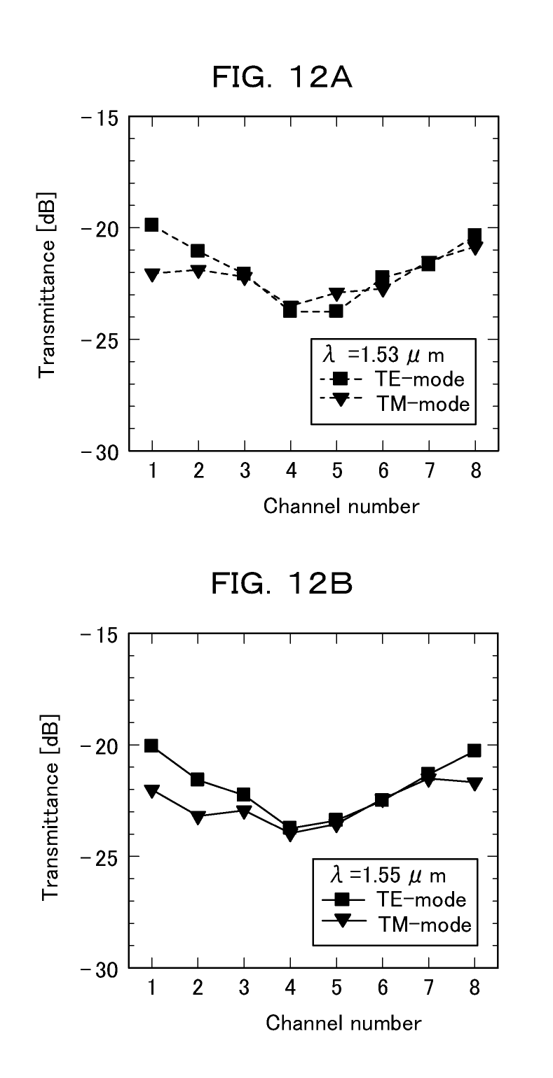

On the other hand, FIGS. 12A and 12B each illustrate characteristics indicative of interchannel imbalance of the above-described comparative example (see FIG. 3). Specifically, FIG. 12A illustrates transmittances of each channel (each output port) for TE-mode input light and TM-mode input light obtained when the input light wavelength is 1.53 μm, while FIG. 12B illustrates transmittances of each channel (each output port) for TE-mode input light and TM-mode input light obtained when the input light wavelength is 1.55 μm. Device parameters used here each remain the same as in the case of FIG. 3.

As can be seen from FIGS. 12A and 12B, the above-described comparative example has interchannel imbalance of about 4 dB and polarization dependence of about 2 dB and, hence, the comparative example has noticeably increased interchannel imbalance as compared with the present mode-converting optical coupler (see FIGS. 11A and 11B). The comparative example has been experimentally confirmed to exhibit a large characteristic change with varying length of the tapered waveguide, hence, have a small fabrication tolerance.

From the results described above, it has been confirmed that the present mode-converting optical coupler 20 is very effective in terms of interchannel balance and fabrication tolerance.

Thus, the optical waveguide device (i.e., mode-converting optical coupler) according to the present embodiment has the advantages of: making multichanneling possible with a compact device size; suppressing the interchannel imbalance while realizing low wavelength dependence and low polarization dependence; and increasing the fabrication tolerance.

That is, the present optical waveguide device (i.e., mode-converting optical coupler) can maintain the flatness of the light intensity distribution substantially constant at the output end of the tapered waveguide 3 even when the device length varies (by 50 μm or more for example), thereby making it possible to realize high fabrication tolerance. Therefore, the high-performance optical guide device (i.e., mode-converting optical coupler) 20 having excellent characteristics in terms of interchannel balance (i.e., excellent interchannel balance characteristics) can be fabricated in high yield even when inexpensive photolithography equipment is used.

While the foregoing embodiment has been described by exemplifying the tapered waveguide 3 widening linearly (which is a tapered waveguide having planar side surfaces or a linear tapered waveguide having a linearly changing tapered shape), the concepts discussed herein are not limited to this feature. The shape of the tapered waveguide may be modified variously unless the tapered waveguide allows the self-imaging phenomenon to occur therein.

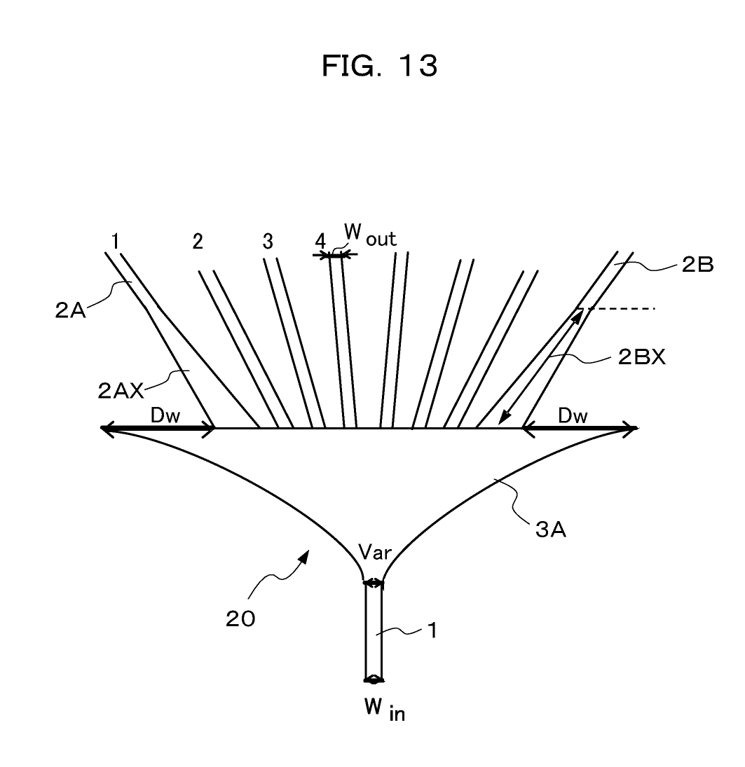

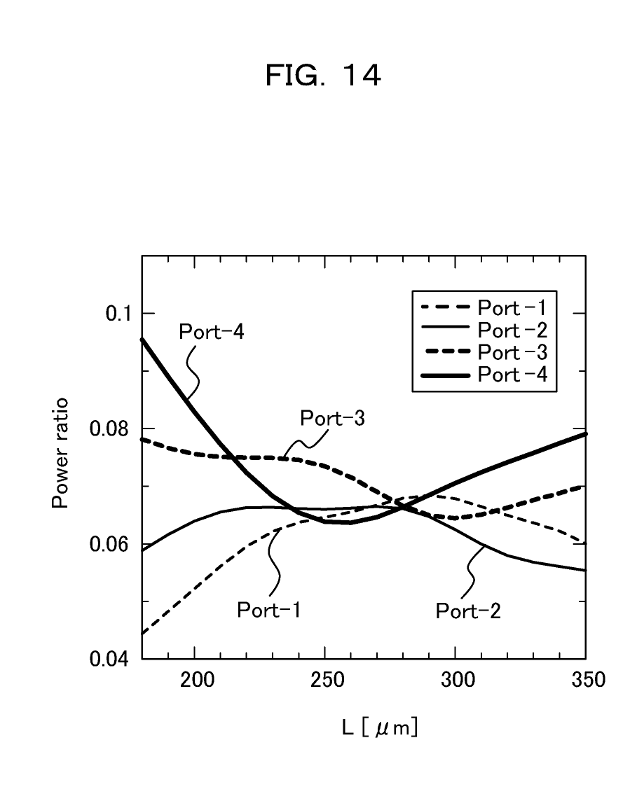

For example, the tapered waveguide may be a tapered waveguide 3A widening exponentially (i.e., a tapered waveguide having curved side surfaces or a curving tapered waveguide having a curvingly changing tapered shape). In FIG. 13, numbers 1 to 4 given to four output waveguides correspond to ports 1 to 4 of FIG. 14. Mode-converting optical coupler 20 having such a tapered waveguide 3A can be fabricated by the same fabrication process as employed for the foregoing embodiment.

FIG. 14 illustrates power ratios indicative of transmission characteristics of the mode-converting optical coupler 20 having the tapered waveguide 3A widening exponentially.

Though FIG. 14 illustrates the transmission characteristics of only four channels (specifically, the ratios of light powers outputted from four output ports (ports 1 to 4) to a light power inputted from the single input port; i.e., transmittances), the transmission characteristics of the other four channels are identical with the respective transmission characteristics illustrated because the device has a symmetric structure with respect to a central axis thereof.

Here, the widest end width of the tapered waveguide 3A, which is used as a device parameter, is set to 108 μm. Other parameters (including the width of each of the input waveguide 1 and output waveguides 2, the narrowest end width of the tapered waveguide 3, the space between adjacent ones of the output waveguides 2, and the widest end width, narrowest end width and length of each of the tapered portions 2AX and 2BX of the outermost output waveguides 2A and 2B) each remain the same as in the case of FIG. 2.

As can be seen from FIG. 14, the mode-converting optical coupler employing the structure having the tapered waveguide 3A which widens exponentially, maintains a state in which variations in transmission characteristic among the output ports (i.e., channels) are small even when the length (L) of the tapered waveguide 3A varies, like the foregoing embodiment. For this reason, a flat light intensity distribution is maintained at the output end of the tapered waveguide 3A even when the length of the tapered waveguide 3A varies.

Assuming that an allowable range of variations in transmission characteristic among the channels is 0.5 dB, the present mode-converting optical coupler 20 has a device length margin of about 45 μm as illustrated in FIG. 14. As can be seen therefrom, the mode-converting optical coupler has substantially increased fabrication tolerance, like the foregoing embodiment.

While the foregoing embodiment has been described by exemplifying the 1×8 mode-converting optical coupler, the present invention is not limited thereto. It is needless to say that the embodiments of the present invention discussed herein are applicable to any mode-converting optical coupler which is different in the number of ports from the foregoing embodiment.

While the foregoing embodiment has been described by demonstrating the device characteristics of the 1×8 mode-converting optical coupler used as an optical branch, the device, when used as an optical coupler (i.e., optical multiplexer) by using the input and output waveguides in reverse, can exercise an effect similar to the effect of the foregoing embodiment.

In this case, the mode-converting optical coupler simply includes one single-mode output waveguide (first waveguide), a plurality of input waveguides (second waveguides), and a tapered waveguide having first end connected to the output waveguide and a second end connected to the input waveguides and gradually widening as the tapered waveguide extends from first end (i.e., output-side end or output end) toward a second end (i.e., input-side end or input end), wherein first end width of the tapered waveguide is set to satisfy the single-mode condition. Other features, including the fabrication method, of this device may be identical with those of the foregoing first embodiment as long as the input and output waveguides are used in reverse.

While the foregoing embodiment has been described by exemplifying the optical waveguide device including only the mode-converting optical coupler 20 formed on the semiconductor substrate, it is possible to integrate other optical functional devices and optical waveguides, including a semiconductor optical amplifier, semiconductor laser (i.e., laser light source), optical modulator, phase modulator, and optical filter, on the semiconductor substrate on which the optical waveguide device (i.e., mode-converting optical coupler) 20 is formed.

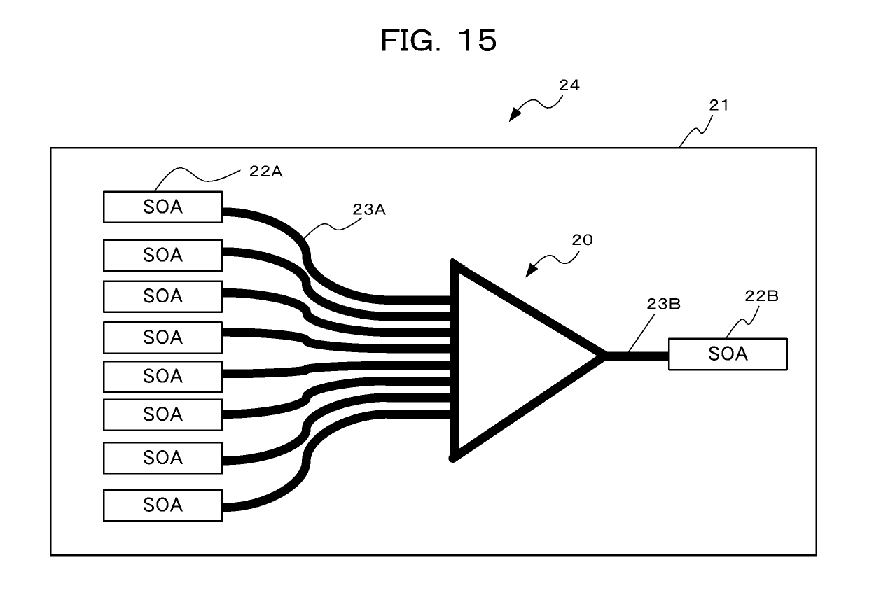

An optical gate switch 24, as illustrated in FIG. 15 for example, includes the optical waveguide device (i.e., mode-converting optical coupler) 20 according to the foregoing embodiment, semiconductor optical amplifiers (SOAs) 22A and 22B, and optical waveguides 23A and 23B, which are monolithically integrated on a single semiconductor substrate (the same substrate) 21. Here, the plurality of SOAs 22A (SOA gate array) are connected to the input side of the mode-converting optical coupler 20 through the plurality of bending waveguides (i.e., input waveguides) 23A, while the single SOA 22B is connected to the output side of the mode-converting optical coupler 20 through the single optical waveguide (i.e., output waveguide) 23B.

Such an optical gate switch 24 is capable of picking up optical signals from a desired channel by a current control over the plurality of SOAs 22A located on the input side. At that time, the optical gate switch 24 is capable of high-quality optical signal processing because the mode-converting optical coupler 20 according to the foregoing embodiment maintains constant the light intensity of a wavelength-multiplexed optical signal or an optical signal not polarization-controlled by virtue of its low wavelength dependence, low polarization dependence and excellent interchannel balance characteristics.

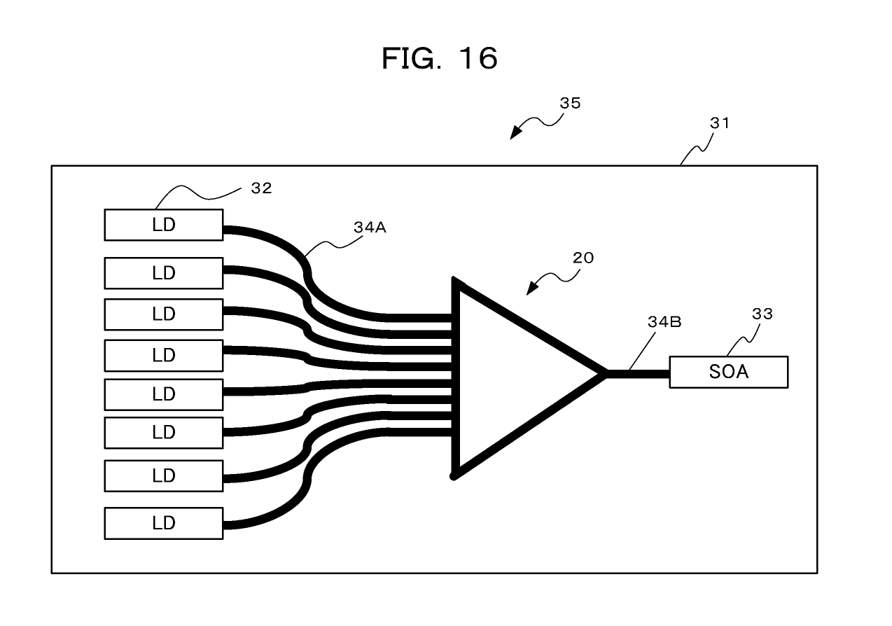

A tunable laser (i.e., tunable light source) 35 as an optical integrated device, as illustrated in FIG. 16 for example, includes the optical waveguide device (i.e., mode-converting optical coupler) 20 according to the foregoing embodiment, semiconductor lasers (i.e., laser diodes (LDs)) 32, a semiconductor optical amplifier (SOA) 33, and optical waveguides 34A and 34B, which are monolithically integrated on a single semiconductor substrate (the same substrate) 31. Here, the plurality of semiconductor lasers 32 are connected to the input side of the mode-converting optical coupler 20 through the plurality of bending waveguides (i.e., input waveguides) 34A, while the SOA 33 is connected to the output side of the mode-converting optical coupler 20 through the single optical waveguide (i.e., output waveguide) 34B.

Each of the semiconductor lasers 32 may comprise a temperature controllable distributed feedback (DFB) laser, a current injection controlled TDA (tunable distributed amplification)-DFB laser, or the like. In this case, each of the semiconductor lasers 32 is capable of wavelength tuning over a wavelength range of several nanometers. Accordingly, the tunable laser using the mode-converting optical coupler 20 according to the foregoing embodiment is capable of a broadband wavelength tuning operation throughout the C band and L band. The tunable laser can maintain constant the laser output powers of all the channels by virtue of the low wavelength dependence and excellent interchannel balance characteristics of the mode-converting optical coupler according to the foregoing embodiment.

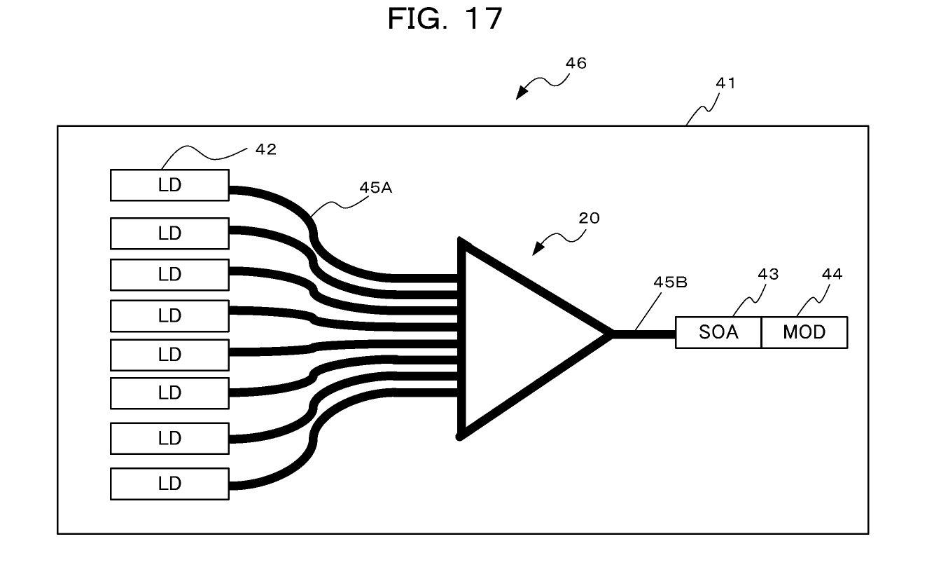

An external modulator integrated tunable laser (i.e., external modulator integrated tunable light source) 46 as an optical integrated device, as illustrated in FIG. 17 for example, includes the optical waveguide device (i.e., mode-converting optical coupler) 20 according to the foregoing embodiment, semiconductor lasers (i.e., laser diodes (LDs)) 42, a semiconductor optical amplifier (SOA) 43, an optical modulator (MOD) 44, and optical waveguides 45A and 45B, which are monolithically integrated on a single semiconductor substrate (the same substrate) 41. Here, the plurality of semiconductor lasers 42 are connected to the input side of the mode-converting optical coupler 20 through the plurality of bending waveguides (i.e., input waveguides) 45A, while the SOA 43 and the MOD 44 are connected to the output side of the mode-converting optical coupler 20 through the single optical waveguide (i.e., output waveguide) 45B.

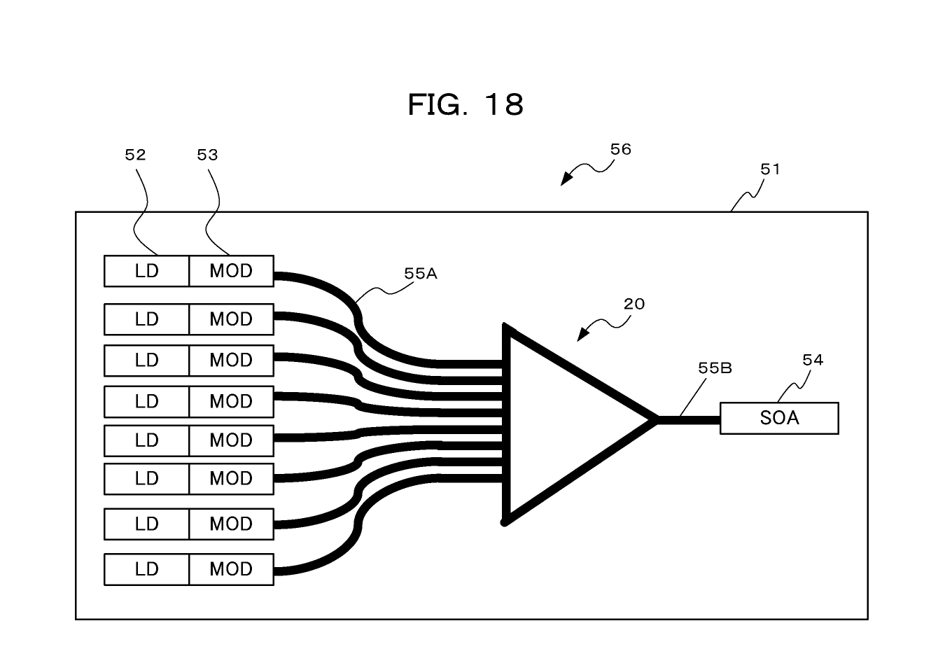

An optical integrated device 56, as illustrated in FIG. 18 for example, includes the optical waveguide device (i.e., mode-converting optical coupler) 20 according to the foregoing embodiment, semiconductor lasers (i.e., laser diodes (LDs)) 52, optical modulators (MODs) 53, a semiconductor optical amplifier (SOA) 54, and optical waveguides 55A and 55B, which are monolithically integrated on a single semiconductor substrate (the same substrate) 51. Here, the plurality of semiconductor lasers 52 and the plurality of MODs 53 are connected to the input side of the mode-converting optical coupler 20 through the plurality of bending waveguides (i.e., input waveguides) 55A, while the SOA 54 is connected to the output side of the mode-converting optical coupler 20 through the single optical waveguide (i.e., output waveguide) 55B.

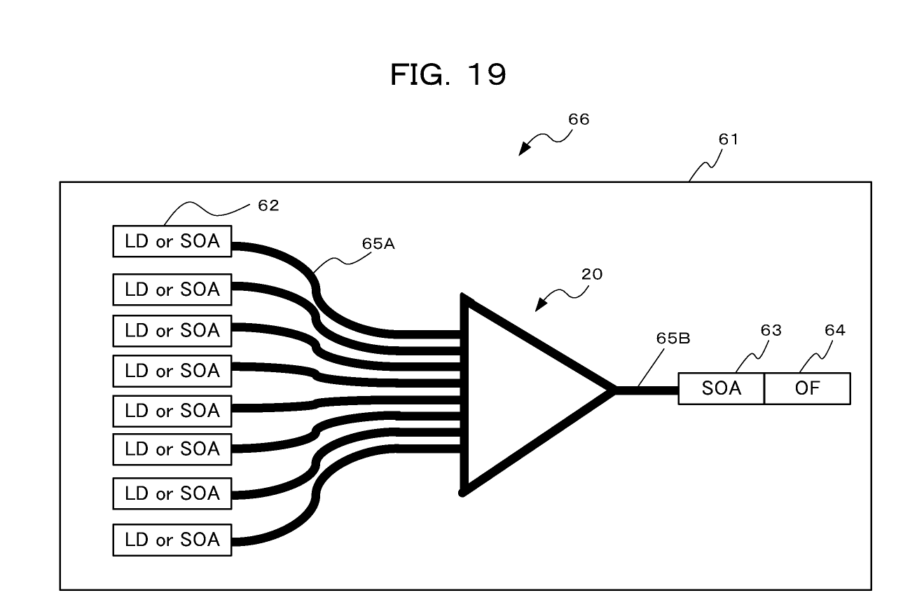

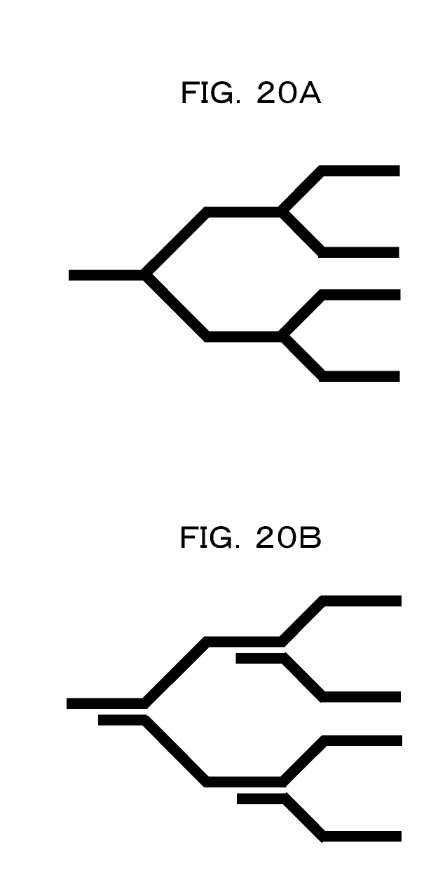

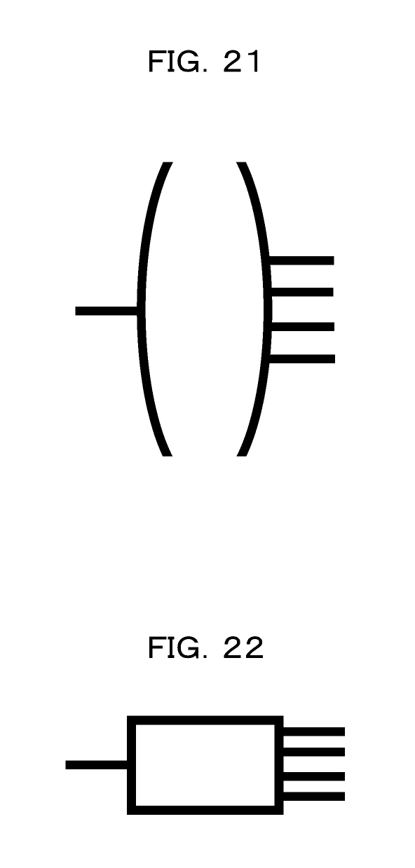

An optical integrated device 66, as illustrated in FIG. 19 for example, includes the optical waveguide device (i.e., mode-converting optical coupler) 20 according to the foregoing embodiment, semiconductor lasers (i.e., laser diodes (LDs)) or semiconductor optical amplifiers (SOAs) 62, a semiconductor optical amplifier (SOA) 63, an optical filter (OF) 64, and optical waveguides 65A and 65B, which are monolithically integrated on a single semiconductor substrate (the same substrate) 61. Here, the plurality of semiconductor lasers (or SOAs) 62 are connected to the input side of the mode-converting optical coupler 20 through the plurality of bending waveguides (i.e., input waveguides) 65A, while the SOA 63 and the OF 64 are connected to the output side of the mode-converting optical coupler 20 through the single optical waveguide (i.e., output waveguide) 65B. This configuration is capable of eliminating a spontaneous emission light component from the SOA. Also, this configuration is capable of picking up only a desired wavelength component when a wavelength-multiplexed signal train is inputted.

Such optical integrated devices (including the above-described optical waveguide device) make highly functional optical signal processing possible. A transmitter or receiver provided with such a highly functional optical integrated device (including the above-described optical waveguide device) exhibits high performance. Further, an optical transmission device connected to such a transmitter or receiver through an optical transmission line also exhibits high performance.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An optical waveguide device, comprising:
a first waveguide;
a plurality of second waveguides; and
a tapered waveguide including a first end connected to the first waveguide and a second end connected to the plurality of the second waveguides and configured to receive input of a single-mode light from the first waveguide, the tapered waveguide widening as the tapered waveguide extends from the first end toward the second end.

2. The optical waveguide device according to claim 1, wherein the second end of the tapered waveguide includes projecting regions projecting outwardly from a region connected to the plurality of the second waveguides.

3. The optical waveguide device according to claim 2, wherein the projecting regions each have a length of not less than 10 μm, and the tapered waveguide has a length ranging from 250 μm to 310 μm.

4. The optical waveguide device according to claim 2, wherein a light intensity distribution in the region connected to the plurality of the second waveguides is substantially flat.

5. The optical waveguide device according to claim 1, wherein the tapered waveguide has a width at the first end which is substantially equal to a width of the first waveguide.

6. The optical waveguide device according to claim 1, wherein the tapered waveguide is a linearly widening tapered waveguide.

7. The optical waveguide device according to claim 1, wherein the tapered waveguide is an exponentially widening tapered waveguide.

8. The optical waveguide device according to claim 1, wherein a transmission characteristics of each of the second waveguides is substantially equal to each other.

9. The optical waveguide device according to claim 1, wherein outermost second waveguides of the plurality of the second waveguides each having a tapered portion widening as the tapered portion extends toward the second end of the tapered waveguide.

10. The optical waveguide device according to claim 9, wherein the tapered portion has a taper angle for converting a higher-order mode to a single mode.

11. An optical integrated device comprising:
an optical waveguide device which includes
a first waveguide,
a plurality of second waveguides, and
a tapered waveguide including a first end connected to the first waveguide and a second end connected to the plurality of the second waveguides and configured to receive input of a single-mode light from the first waveguide, the tapered waveguide widening as the tapered waveguide extends from the first end toward the second end; and
optical functional devices integrated on a semiconductor substrate on which the optical waveguide device is formed while being optically connected to the optical waveguide device.

12. The optical integrated device according to claim 11, wherein the second end of the tapered waveguide includes projecting regions projecting outwardly from a region connected to the plurality of the second waveguides.

13. The optical integrated device according to claim 12, wherein the optical functional devices include:
an optical amplifier connected to the first waveguide; and
optical amplifiers wherein each of the optical amplifiers being connected to a respective one of the second waveguides.

14. The optical integrated device according to claim 12, wherein the optical functional devices include:
lasers wherein each of the lasers being connected to a respective one of the second waveguides; and
an optical amplifier connected to the first waveguide.

15. The optical integrated device according to claim 12, wherein the optical functional devices include:
lasers wherein each of the lasers being connected to a respective one of the second waveguides;
an optical amplifier connected to the first waveguide; and
an optical modulator connected to the optical amplifier.

16. The optical integrated device according to claim 12, wherein the optical functional devices include:
optical modulators wherein each of the optical modulators being connected to a respective one of the second waveguides;
lasers each connected a respective one of the optical modulators; and
an optical amplifier connected to the first waveguide.

17. The optical integrated device according to claim 12, wherein the optical functional devices include:
lasers or optical modulators wherein each of the lasers or the modulators being connected to a respective one of the second waveguides of the optical waveguide device;
an optical amplifier connected to the first waveguide of the optical waveguide device; and
an optical filter connected to the optical amplifier connected to the first waveguide.

18. An optical transmission system comprising:
a transmitter including
a first optical waveguide device including
a first waveguide,
a plurality of second waveguides, and
a first tapered waveguide including a first end connected to the first waveguide and a second end connected to the plurality of the second waveguides and configured to receive input of a single-mode light from the first waveguide, the first tapered waveguide widening as the tapered waveguide extends from the first end toward the second end; and
first optical functional devices integrated on a first semiconductor substrate on which the first optical waveguide device is formed while being optically connected to the first optical waveguide device; and
a receiver including
a second optical waveguide device including
a third waveguide,
a plurality of fourth waveguides, and
a second tapered waveguide including a third end connected to the third waveguide and a fourth end connected to the plurality of the fourth waveguides and configured to receive input of a single-mode light from the third waveguide, the second tapered waveguide widening as the tapered waveguide extends from the third end toward the forth end; and
second optical functional devices integrated on a second semiconductor substrate on which the second optical waveguide device is formed while being optically connected to the second optical waveguide device.

19. The optical waveguide device according to claim 18, wherein the second end of the first tapered waveguide includes first projecting regions projecting outwardly from a region connected to the plurality of the second waveguides.

20. The optical waveguide device according to claim 18, wherein the third end of the second tapered waveguide includes second projecting regions projecting outwardly from a region connected to the plurality of the fourth waveguides.
